(19) United States
(12) Patent Application Publication
(10) Pub. No.: US 2026/0111400 A1
(43) Pub. Date: Apr. 23, 2026

(54) SYSTEM

(71) Applicant: SOFTBANK GROUP CORP., Tokyo (JP)

(72) Inventor: Akihiko ONISHI, Tokyo (JP)

(73) Assignee: SOFTBANK GROUP CORP., Tokyo (JP)

(21) Appl. No.: 19/357,156

(22) Filed: Oct. 14, 2025

(30) Foreign Application Priority Data
Oct. 17, 2024 (JP) 2024-181641

(51) Int. Cl. G06F 16/21

(52) U.S. Cl. CPC G06F 16/217

(57) ABSTRACT

A system includes a processor that receives data collected from a terminal, analyzes the received data using a generative model and generates dictionary data for data compression, distributes the generated dictionary data to the terminal so that it is used in subsequent data communications, and ensures communication security by using encryption technology.

### CROSS-REFERENCE TO RELATED APPLICATION

This application is based on and claims priority under 35 USC 119 from Japanese Patent Application No. 2024-181641 filed on Oct. 17, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, IoT devices with limited processing power and communication resources have increasingly been deployed in a wide range of fields. However, efficient and secure data communication remains a significant challenge for such devices, especially when unsophisticated compression methods and conventional security protocols are used. As a result, there is a need for a system that can reduce the communication load, enhance data transfer efficiency, and maintain high levels of security for resource-constrained IoT terminals.

### SUMMARY

To solve the aforementioned problem, the present invention provides a system comprising a processor that receives data collected from a terminal, analyzes the received data using a generative model to generate dictionary data for efficient data compression, and distributes the generated dictionary data to the terminal for use in subsequent transmissions. The system further ensures the security of data communications by implementing encryption technology. This dynamic generation and distribution of compression dictionaries enable low-specification IoT devices to achieve both efficient and secure data transmission, thereby overcoming the limitations of conventional methods.
“processor” means a hardware or software component capable of executing instructions and performing data processing tasks within the system.
“terminal” means an endpoint device, such as an IoT device, which collects data and communicates with the system.
“generative model” means an artificial intelligence model capable of analyzing data and producing patterns or dictionaries used for data compression.
“dictionary data” means structured information generated by the generative model that maps specific data values or patterns to compressed codes for the purpose of data compression.
“data compression” means a process in which the size of data is reduced by encoding information in a more efficient format, making transmission more efficient.
“encryption technology” means a method or protocol used to protect data during communication by converting the data into a secure format that cannot be easily interpreted by unauthorized parties.
“data communication” means the exchange of data between the terminal and the system, which may involve both transmission and reception of information.
“compressed data” means data that has been processed and reduced in size using the generated dictionary data before being transmitted or stored.
“decompress” means a process of restoring compressed data back to its original or usable form using the corresponding dictionary data.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

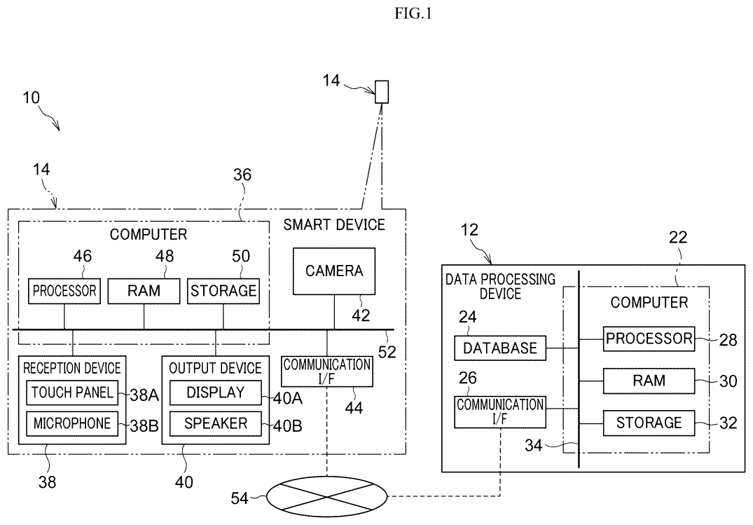

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

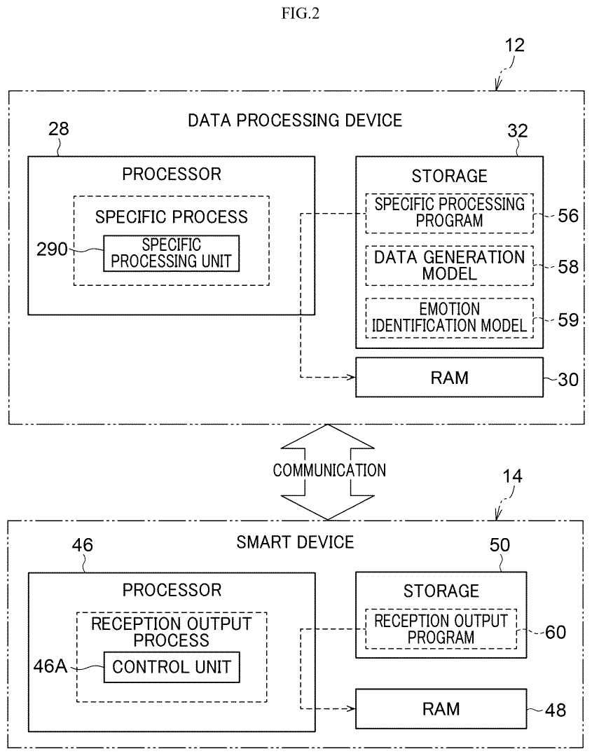

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like).

Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In recent information and communication systems, there is a demand for terminals, including those with limited processing capabilities, to transmit large-volume data both efficiently and securely. However, existing methods often struggle to maintain communication efficiency and data security on such low-specification terminals. Furthermore, there is a lack of means to carry out real-time information monitoring while ensuring rapid and protected data transfer. Therefore, there is a need for a system that enables efficient, secure, and real-time communication and data monitoring regardless of the terminal's performance.

The specific processing by the specific processing unit 290 of the data processing device 12 in Example 1 is realized by the following means.

The present invention provides a server comprising a processor configured to receive information from an information terminal, analyze the received information using a generative artificial intelligence model, generate encoding information for data compression based on data characteristics, distribute the encoding information to the information terminal, and apply encryption to bi-directional communication. This enables efficient and secure data transmission between the terminal and the server, allows optimized real-time data compression and decompression tailored for each terminal, and provides real-time monitoring capabilities through data visualization, regardless of the performance level of the terminal.

The term “information terminal” refers to a communication device equipped with an input device or a measurement device for acquiring data, and capable of transmitting and receiving information over a communication network.

The term “processor” refers to a central processing unit or computational device that executes instructions for data processing, analysis, and control of system operations.

The term “generative artificial intelligence model” refers to a machine learning model that is capable of learning data patterns and generating output data, such as encoding information or dictionaries, based on input information and prompt sentences.

The term “encoding information” refers to data or a data structure generated for the purpose of facilitating efficient data compression and decompression, tailored for specific patterns in the input data.

The term “structured data format” refers to an organized representation of data, such as JSON or XML, which allows for standardized exchange and interpretation of information between devices.

The term “encryption method” refers to a technology or algorithm, such as SSL/TLS, which is used to secure the confidentiality and integrity of data transmitted over a communication path.

The term “prompt sentence” refers to an instruction or textual input provided to the generative artificial intelligence model to guide or refine its processing and output.

The term “compression software” refers to a computer program or library that performs data compression and decompression functions, based on encoding information or a dictionary.

The term “visualization technology” refers to a method or software for transforming and displaying data in a graphical or interpretable manner, enabling real-time monitoring and analysis by a user.

An embodiment for implementing the present invention will be described below. The system comprises a server and one or more information terminals such as IoT devices, smartphones, or embedded hardware equipped with sensors and communication modules. The information terminal includes an input device or a measurement device, such as a temperature sensor or touch screen, for acquiring data. The server is a general-purpose computing device equipped with a processor, sufficient memory, and storage, operating a web application environment such as a Linux server with a database (for example, PostgreSQL or MySQL). Both server and terminals are connected via a communication network such as the Internet. The information terminal is configured to collect data from sensors or input devices. The terminal stores this data temporarily and then transmits it to the server over a secure channel using HTTPS, which implements SSL/TLS encryption protocols. For handling data and communication, the terminal may use operating system-level cron jobs for scheduled operations and include compression libraries such as zlib for subsequent compression tasks.

The server receives the transmitted data and stores it in a structured database for later processing. The server uses a generative artificial intelligence model, which may be implemented with a machine learning library such as TensorFlow. The server applies the generative AI model to analyze incoming data and generate encoding information (i.e., dictionary data) designed for efficient data compression tailored to characteristics of the collected data. The server can use prompt sentences to instruct the generative AI model in its analysis and dictionary generation operations. For example, a prompt sentence might be: “Analyze this list of temperature readings collected every five minutes and generate a dictionary for optimal compression of similar time-series sensor data.”

Once the encoding information has been generated, the server distributes the encoding information to the terminal in a structured data format such as JSON, so the terminal can use the encoding information for later communications. The information terminal, upon receiving the encoding information, uses the data together with existing compression software, such as zlib, to compress newly acquired data before the next transmission to the server.

Throughout all communications between the information terminal and the server, encryption technology ensures the protection of data in transit and prevents unauthorized access or tampering.

When the compressed data is received by the server, the server applies the same encoding information to decompress the data. The server uses the generative AI model and additional visualization software (for example, using a web dashboard technology such as React, Chart.js, or D3.js) to analyze or visually present the restored data. The user may access the visualized data in real time through a web-based dashboard or a similar user interface, enabling real-time monitoring and decision-making regardless of the information terminal's hardware limitations.

In a concrete example, a user installs a temperature sensor in a home environment. The terminal device gathers temperature data and transmits it at fixed intervals to the server. The server analyzes the accumulated temperature records using the generative AI model, generates a custom encoding dictionary, and sends it back to the terminal. The terminal then compresses subsequent temperature data transmissions using the custom dictionary, allowing both secure and efficient communication, while the user can monitor the environment in real time from a web interface.

A prompt sentence example used in this process is:
“Generate an optimized compression dictionary for the provided time-series temperature data.”

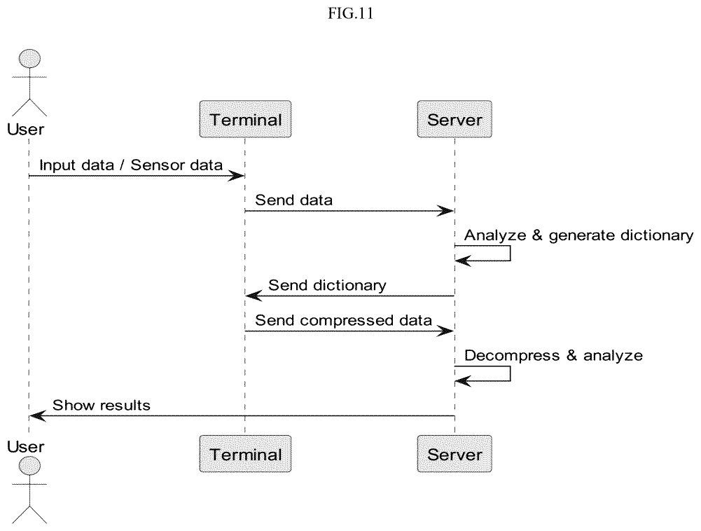

The following describes the processing flow using FIG. 11.

### Step 1

The terminal collects data from a measurement device or input device, such as a temperature sensor or a touch screen. The input is raw sensor readings or user-entered data. The terminal processes this input by formatting the acquired data into a structured local record and stores it temporarily in local storage as the output.

### Step 2

The terminal transmits the stored data to the server via a communication network. The input is the structured local record generated in Step 1. The terminal uses an encryption protocol such as SSL/TLS to secure the data and sends the formatted data in a structured format (for example, JSON) as the output.

### Step 3

The server receives the data sent by the terminal. The input is the encrypted structured data received across the network. The server decrypts the incoming transmission using SSL/TLS, parses the JSON data, and stores the clean, structured information in a persistent storage system such as a database as the output.

### Step 4

The server analyzes the received data using a generative AI model. The input is the stored structured data from the database. The server uses the AI model, prompted with a prompt sentence such as “Generate an optimized compression dictionary for the provided time-series data,” to extract data patterns and generate encoding information (dictionary data) as the output.

### Step 5

The server transmits the generated encoding information to the terminal. The input is the encoding dictionary produced by the AI model in Step 4. The server formats the dictionary using a structured data format such as JSON and sends it to the terminal via the secure network, resulting in the distributed encoding information as the output.

### Step 6

The terminal receives the encoding information from the server and stores it locally. The input is the distributed dictionary data in structured format. The terminal processes the dictionary and configures its compression software (for example, zlib) with the new encoding information, updating its local environment for the next data transfer. The output is the updated local configuration with the new dictionary.

### Step 7

The terminal collects new measurement or input data for subsequent transmission. The input is fresh sensor readings or user-entered values, and the locally stored encoding information (dictionary). The terminal uses the compression software and dictionary to encode the data, resulting in compressed and formatted data as the output.

### Step 8

The terminal encrypts and transmits the compressed data to the server. The input is the compressed data generated in Step 7. The terminal secures the data using SSL/TLS and sends it to the server as the output.

### Step 9

The server receives and processes the compressed, encrypted data. The input is the encrypted compressed data from the terminal. The server decrypts the transmission, decompresses the data using the matching dictionary, and parses it to restore the original structured information as the output.

### Step 10

The server analyzes or visualizes the restored data. The input is the decompressed, structured original data. The server processes the data using the AI model or visualization software, generates analysis results or visual representations, and outputs this information to the user interface for real-time monitoring.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In industrial and distributed environments, efficiently and securely transmitting large volumes of measurement data collected by various sensor-equipped information collection apparatus presents significant challenges. Existing systems are limited by communication costs, computation capability, and issues in maintaining both data compression efficiency and communication security. Furthermore, conventional solutions do not flexibly personalize data communication based on the user's state and emotional condition, which can negatively impact user experience and operational effectiveness.

The specific processing by the specific processing unit 290 of the data processing device 12 in Application Example 1 is realized by the following means.

The present invention provides a server comprising a processor configured to receive measurement information from an information collection apparatus, analyze the measurement information using a generative artificial intelligence model, generate encoding information for compression based on features of the measurement information, distribute the encoding information to the information collection apparatus, use encryption to secure transmissions, acquire user state data, estimate emotional information by emotion determination technology, customize the communication strategy according to the estimated emotional information, and generate prompt sentences for the generative artificial intelligence model. This enables efficient and secure data communication, improves compression rates according to the actual data characteristics, and allows dynamic personalization of data transmission and processing based on the user's emotional state, thereby enhancing operational efficiency and user experience.

The term “information collection apparatus” refers to a hardware device or component that gathers measurement information, such as sensor data, from an environment and transmits it to a server or processor for further analysis.

The term “measurement information” refers to data acquired from the information collection apparatus, including but not limited to physical, environmental, or operational parameters such as temperature, humidity, or status values.

The term “processor” refers to a hardware processing unit or a combination of hardware and software components configured to execute instructions for controlling, analyzing, and managing data and communication processes within the system.

The term “generative artificial intelligence model” refers to an algorithmic or computational model that learns data patterns and produces outputs, including encoding information, based on input data, utilizing generative or machine learning techniques.

The term “encoding information for compression” refers to a set of data or rules generated to efficiently encode and compress measurement information, thereby reducing communication payloads and optimizing transmission.

The term “encryption method” refers to a cryptographic technique or algorithm applied to data transmissions in order to ensure security and prevent unauthorized access or tampering.

The term “user state data” refers to information related to the status, behavior, or context of a user operating or interacting with the system, which may include biometric, physiological, or behavioral inputs.

The term “emotion determination technology” refers to technologies, software, or algorithms that analyze user state data, such as facial expressions or voice signals, to estimate or classify the emotional condition of a user.

The term “prompt sentences” refers to textual or symbolic instructions automatically generated and input to the generative artificial intelligence model to guide its analysis or data processing operations.

An embodiment for practicing the invention relates to a data communication system in which a server and at least one terminal cooperate to acquire, analyze, compress, transmit, and process measurement information while personalizing and securing communications according to user state and emotional information.

The terminal comprises an information collection apparatus, such as environmental sensors (for example, temperature and humidity sensors), a camera, and a microphone. The terminal is realized using a general-purpose computing device, such as a microcontroller or embedded computer, operating an operating system such as Linux or Windows. Sensors are connected via standard hardware interfaces, such as USB or GPIO pins. The terminal collects measurement information and, in cases where user state data is utilized, also acquires facial image and voice data from the user. The terminal formats the collected data and transmits it over a network to the server.

The server, which is typically implemented by a high-performance computing device or a cloud platform, runs software that comprises a processor configured to receive measurement information from the terminal. The server uses software libraries and frameworks such as Python, requests (for HTTP communication), zlib (for data compression and decompression), and cryptography. fernet (for encryption and decryption). The server is also configured to host and execute a generative artificial intelligence model, which may be implemented using machine learning frameworks such as PyTorch or TensorFlow, or accessed via an external API.

Upon receiving measurement information, the server analyzes the data by inputting it to the generative artificial intelligence model and generates encoding information for compression, optimizing compression codes or schemes according to the features of the received data. The server then distributes this encoding information to the terminal so that future transmissions can be compressed more efficiently.

All data transmission between the terminal and server is secured using an encryption method, such as SSL/TLS protocols and/or data encryption libraries, to ensure protection against unauthorized access or tampering.

In embodiments where user state data is collected, the terminal obtains, in addition to environmental measurements, user-related data such as facial expression or voice signals. The server further implements emotion determination technology (this may be realized using image recognition or audio analysis models) to estimate the emotional condition of the user. The server utilizes the estimated emotional information to control communications, such as adjusting the communication priority or updating the encoding scheme for compression. For example, when the user is estimated to be under stress, the server may give higher priority to certain alerts or operational data, or make the compression method more robust yet adaptive. The server may also generate prompt sentences for the generative artificial intelligence model, which provide instruction or context to optimize analysis and dictionary generation. Example prompt sentences include:
“Please describe a secure and efficient way to compress and transmit temperature and humidity data collected in a factory environment.”
“Suggest a method to use sensor data and user emotion recognition to enable personalized data communication strategies in an industrial IoT system.”
“How can I utilize a generative AI model to create compression dictionaries for industrial sensor data and ensure secure data transfer using Python?” This embodiment enables efficient and secure data communication in real-time industrial or distributed environments, provides enhanced compression tailored to actual data features, and achieves dynamic, emotion-adaptive personalization, thereby improving both operational efficiency and system usability.

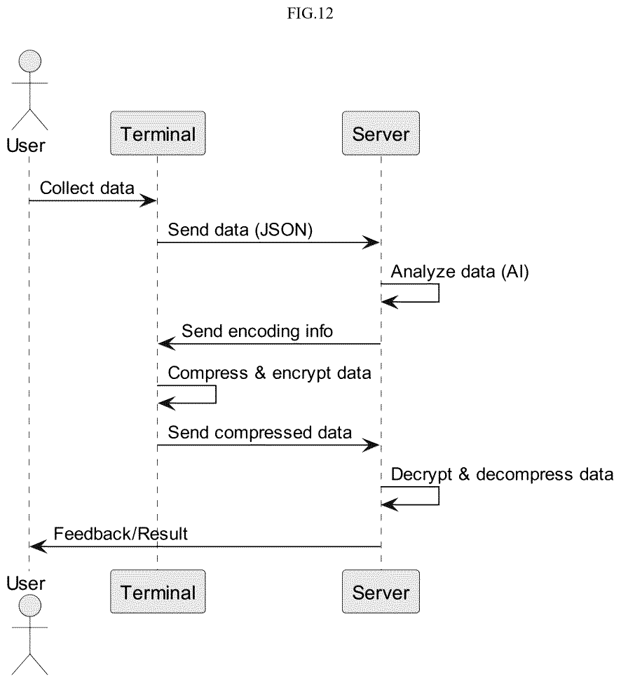

The following describes the processing flow using FIG. 12.

### Step 1

The terminal activates its connected environmental sensors to collect measurement information, such as temperature and humidity values. The terminal may also activate a camera and microphone to acquire user state data, such as facial images and voice signals. As input, the sensors and devices provide raw data, which the terminal processes by formatting into structured records including timestamps. The output is a collection of formatted measurement and user state data, temporarily stored in the terminal's local memory.

### Step 2

The terminal converts the collected data into a suitable transmission format, typically JSON. The input is the structured measurement and user state data from memory. The terminal serializes this data using a software library and prepares a JSON object for communication.

The output is a JSON-formatted data payload ready to be sent.

### Step 3

The terminal transmits the JSON data payload to the server via a secure communication channel, such as HTTPS using SSL/TLS encryption. The input is the JSON payload, and the output is an HTTP POST request containing the data, sent to the server's specified endpoint.

### Step 4

The server receives the HTTP POST request and parses the JSON data. The input is the transmitted JSON data payload. The server verifies the data integrity and confirms the inclusion of required fields. The output is a validated and parsed data structure, now available in the server's memory.

### Step 5

The server analyzes the received measurement information by generating a prompt sentence that describes the analytic task to the generative AI model. The input is the validated data and a generated prompt sentence. The server submits both to the generative AI model, which processes the content to detect patterns suitable for efficient encoding. The output is a set of encoding information for compression, such as dictionary codes based on the structure and distribution of the measurement data.

### Step 6

The server transmits the encoding information for compression back to the terminal. The input is the newly generated encoding information. The server formats it according to the terminal's requirements and sends it via a secure protocol. The output is a successful delivery of encoding information, which the terminal stores locally for future use.

### Step 7

Upon receiving new encoding information, the terminal prepares to use it for subsequent data transmissions. The input is the received encoding information. The terminal updates its local mapping table, so that future measurement data can be transformed into a compressed format. The output is an updated internal configuration in the terminal, which includes the new encoding logic.

### Step 8

When the terminal collects new measurement information, the terminal encodes this data using the stored encoding information for compression. The input is fresh measurement data and the current encoding information. The terminal applies encoding and compresses the result using, for example, a zlib library. The output is a compressed data payload, now significantly reduced in size.

### Step 9

The terminal encrypts the compressed data payload using a cryptographic technique, such as a symmetric key with a cryptography library. The input is the compressed payload and the encryption key. The terminal processes the data to produce an encrypted blob. The output is an encrypted data payload ready for secure network transmission.

### Step 10

The terminal transmits the encrypted, compressed data back to the server over a protected communication channel. The input is the encrypted payload. The action involves packaging the data as an HTTP POST request and delivering it to the server endpoint. The output is a completed secure data transfer.

### Step 11

The server receives the encrypted data payload and performs decryption using the corresponding cryptographic key. The input is the encrypted payload. The server applies decryption and decompresses the payload using a decompression library. The output is restored measurement information in an analyzable format.

### Step 12

The server analyzes the decompressed measurement data to detect operational patterns, trends, or anomalies. If user state data was included, the server applies emotion determination technology, such as image or audio recognition models, to estimate the user's emotional condition. The input is the restored measurement and user state data. The server processes and interprets the data, producing new information such as detected anomalies, emotional state estimates, control signals, or system notifications as output.

### Step 13

The server may modify its communication strategy or update the encoding information for compression based on the analyzed measurement and emotional data. The input is the previous analysis results. The server makes adjustments, such as changing priority levels or updating prompt sentences for its generative AI model. The output is a dynamically adaptive system configuration and feedback sent to the terminal or user as needed.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional data communication systems, it is difficult to efficiently compress large volumes of data and provide adaptive communication based on the user's emotional state, while also ensuring secure data transfer between devices. Existing technologies often lack the capability to analyze complex user contexts and fail to dynamically optimize communication content and priority in response to user emotional changes. Therefore, there is a need for a system that can both enhance communication efficiency and improve user experience by flexibly adapting to the user's emotions in real time.

The specific processing by the specific processing unit 290 of the data processing device 12 in Example 2 is realized by the following means.

The present invention provides a server comprising a processor configured to receive data acquired from an observation device, analyze the received data using a machine learning model to generate reference information for data compression, distribute the generated reference information to the observation device, apply encryption methods to ensure information security, utilize an emotion analysis apparatus to identify a user's emotional state, and determine communication priority based on the identified emotional information. This enables efficient and secure data communication as well as adaptive content delivery tailored to the user's emotional condition, thereby improving overall system performance and user satisfaction.

The term “processor” refers to a hardware computing unit or circuitry that is capable of executing instructions and controlling the operations of the system components.

The term “observation device” refers to an apparatus or sensor configured to acquire data from its environment or from a user, such as a camera, microphone, or physical sensor.

The term “data” refers to any information, including signals, measurements, images, or audio, acquired from the observation device and subject to processing by the system.

The term “machine learning model” refers to an algorithm or software entity trained to perform data analysis, prediction, or classification based on datasets, including models for generative or inferential computation.

The term “reference information” refers to data sets, dictionaries, or statistical parameters generated for the purpose of facilitating efficient data compression or reconstruction.

The term “data compression” refers to the process of encoding data using fewer bits by applying patterns or algorithms to reduce the size of the original information.

The term “encryption method” refers to a cryptographic technique applied to data or communication channels to ensure confidentiality and protection against unauthorized access.

The term “emotion analysis apparatus” refers to a hardware or software unit capable of identifying or estimating a user's emotional state from input data, such as facial images, voice signals, or other sensor outputs.

The term “emotional state” refers to a condition or classification of a user's feelings, such as stress, satisfaction, or frustration, as determined by the emotion analysis apparatus.

The term “communication priority” refers to an order or ranking assigned to data or messages, specifying the sequence or importance for transmission or processing based on contextual information including user emotions.

One embodiment of the invention provides a data communication system that enables efficient, secure, and adaptive information transfer between an observation device (serving as a terminal) and a processor (serving as a server), utilizing a machine learning model and emotion analysis to optimize system performance and user experience.

The terminal is equipped with one or more sensors, such as temperature sensors, cameras, and microphones, which are responsible for collecting raw data from the environment or directly from the user. This data may include environmental readings, visual images, and audio signals. The terminal converts analog data to digital form using built-in analog-to-digital conversion circuits, and may preprocess the data to remove background noise or irrelevant information.

The terminal employs software running on its embedded processor, such as an embedded Linux environment, to encrypt the processed data using a cryptographic method like AES or RSA, utilizing standard libraries for cryptography. The encrypted data is then packaged, annotated with metadata such as timestamps and device identification, and transmitted to the server over a secure communication protocol, such as HTTPS or MQTT.

The server receives the encrypted data via a secure socket interface implemented with widely-used server software, such as a Python-based aiohttp server or a Node.js-based HTTPS server. Upon reception, the server applies decryption using a shared or private cryptographic key, handled by software tools including PyCryptodome, OpenSSL, or system-native cryptographic modules. The decrypted data is then parsed to extract relevant measurements and user information.

The server utilizes a machine learning model, such as a generative AI model implemented by open-source frameworks like TensorFlow or PyTorch, to analyze the extracted data. The model may process the data by categorizing events, detecting anomalies, or summarizing user context. The server inputs specific prompt sentences to the generative AI model, for example: “When a user expresses frustration about missing eggs in the refrigerator, how should the system respond to improve the user experience?”

Through this analysis, the server generates reference information, such as compression dictionaries or statistical patterns, which are optimized for data compression in future communication cycles. The reference information is stored in a database system, such as MongoDB, and distributed back to the terminal via secure channels, accompanied by version management metadata.

The server also utilizes an emotion analysis apparatus, which may include hardware accelerators such as a GPU and software libraries such as OpenCV or openSMILE, to analyze user-derived data for the detection of emotional states, including stress, satisfaction, or frustration. The server employs pre-trained models for emotion recognition, with training data from standard datasets such as FER2013 or RAVDESS.

Based on the detected user emotion, the server calculates a communication priority for each data item or event. For instance, if the server identifies that the user is frustrated due to missing food items, it prioritizes the generation of recommendations for substitutes or recipes not requiring the missing items.

The distributed reference information is used by the terminal to perform compressed data transmission in subsequent sessions, which reduces bandwidth usage and improves communication efficiency. The terminal also utilizes the priority information to present timely and relevant notifications or content to the user, such as recipe recommendations or proactive status alerts.

As an illustrative example, if the user encounters a lack of eggs in a smart refrigerator, the terminal collects voice and image data indicating the user's frustrated reaction. The terminal encrypts and sends this data to the server, where a generative AI model and an emotion analysis apparatus determine the user's emotional state and context. The server then prioritizes the communication of solutions, such as eggless recipe suggestions, and provides updated reference data to support continued efficient data transfer and personalized user experience.

A representative prompt example employed in the system is:

“Given sensor data from a smart appliance and a user's negative vocal reaction, generate optimized communication data and suggest high-priority information to present to the user.” This embodiment shows that the invention can be realized using general-purpose hardware and widely available machine learning and cryptographic software technologies, making it applicable in a variety of information communication and user-adaptive systems.

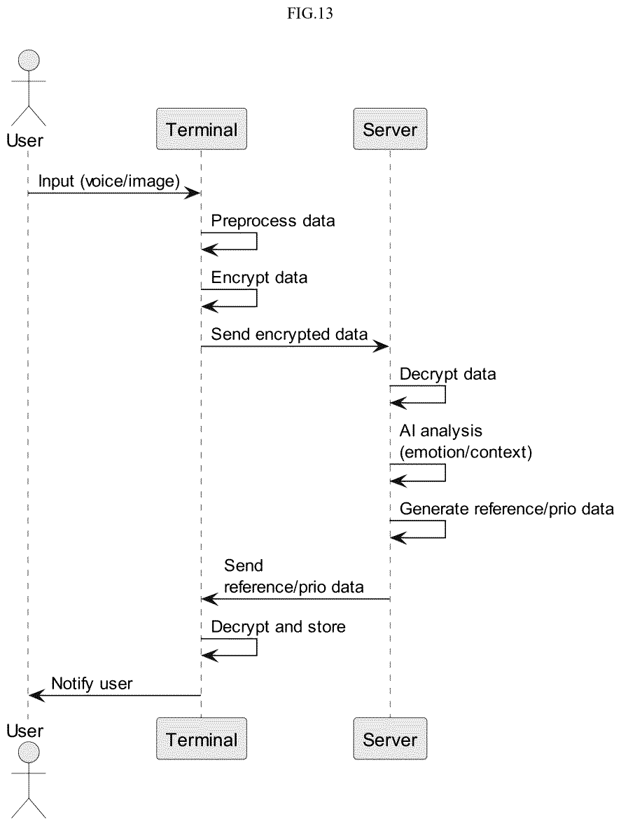

The following describes the processing flow using FIG. 13.

### Step 1

The terminal acquires raw data from multiple observation devices, such as temperature sensors, cameras, and microphones. As an example, the terminal might collect an image of the inside of a refrigerator and record the user's voice feedback. The input is the sensor readings and user input signals. The terminal converts analog signals to digital data using an analog-to-digital converter, preprocesses the data by performing operations such as noise reduction or image resizing, and stores the processed data in its local storage. The output is the processed digital data (e.g., filtered images, cleaned audio files).

### Step 2

The terminal encrypts the preprocessed digital data using a cryptographic algorithm, such as AES-256 or RSA, implemented by its embedded software libraries. The input is the processed digital data from Step 1. The terminal applies encryption to secure the information, packages the encrypted data along with metadata (such as a timestamp and device ID) into a structured format (e.g., JSON), and prepares it for transmission. The output is the encrypted and packaged data message.

### Step 3

The terminal transmits the encrypted data message to the server through a secure communication protocol, such as HTTPS or MQTT. The input is the encrypted and formatted data message. The terminal establishes a secure network session using SSL/TLS, sends the message, and awaits confirmation from the server. The output is the successful delivery and server receipt of the data.

### Step 4

The server receives the encrypted data from the terminal using its network interface. The input is the encrypted data message delivered over the network. The server identifies the data source, verifies the data integrity, and applies decryption using appropriate keys and cryptographic modules (e.g., OpenSSL or platform-specific libraries). The output is the decrypted and validated digital data along with associated metadata.

### Step 5

The server analyzes the decrypted data using a generative AI model (for example, a neural network implemented in TensorFlow or PyTorch). The input is the decrypted sensor readings, images, and audio files from Step 4. The server formats a prompt sentence and provides it to the AI model (e.g., “Given the user's voice expressing frustration and the inventory data, summarize the situation and suggest suitable actions”). The server processes the AI output by categorizing events, detecting anomalies, and summarizing findings. The output is the analysis result and summarized context information.

### Step 6

The server generates reference information for future data compression by extracting common data patterns or statistical features from the analyzed data, using data processing libraries such as scikit-learn or custom scripts. The input is the server's analysis result and context information. The server builds or updates compression dictionaries or reference templates, stores them in a database, and annotates them for revision management. The output is the new or updated reference information for compression.

### Step 7

The server performs emotion analysis by extracting features from user images and audio data, using tools such as OpenCV for facial analysis and openSMILE for audio emotional cues, and applies trained emotion detection models to classify the emotional state of the user. The input is the user's image and audio data. The server calculates facial action units, extracts voice spectral features, and classifies emotions (e.g., neutral, frustrated, satisfied). The output is the user's detected emotional state.

### Step 8

The server prioritizes communication content based on the analyzed emotional state and event context. The input is the emotion classification result and event summary. The server uses algorithms or rule-based logic to increase the priority of information relevant to the detected user emotion, for example, promoting recipe suggestions when frustration about missing ingredients is detected. The output is a ranked list or schedule of prioritized notifications and information.

### Step 9

The server encrypts the updated reference information and prioritized notification list using a secure algorithm, packages it with metadata, and sends it to the terminal. The input is the reference information and prioritized content. The server transmits the message by a secure protocol. The output is the confirmed transmission of updated reference information to the terminal.

### Step 10

The terminal receives the encrypted reference information and prioritized content from the server, decrypts the information, and stores it locally for use in subsequent data compression and user notification cycles. The input is the encrypted server message. The terminal performs decryption and integrates the new information into its operational workflow. The output is the availability of updated reference data and prioritized content within the terminal.

### Step 11

The terminal utilizes the stored reference information to compress new data before the next transmission and uses the priority list to determine which notifications or content to present to the user. The input is the current data to be sent and the latest reference/prioritization data.

The output is efficient, adaptive data transmission and tailored content presentation to the user based on emotional and contextual relevance.

### Step 12

The user interacts with the terminal by reviewing presented information or acting upon the notifications. The input is the display or audio content provided by the terminal. The user's reactions (such as verbal responses or changes in facial expression) are observed and subsequently captured by the terminal for the next processing cycle. The output is the user's response, which becomes new input for the system loop.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional real-world environments, it is difficult to rapidly and accurately identify users'emotional states and flexibly adapt services in real time based on such user emotions. Existing systems do not efficiently capture and utilize individual emotional information for immediate service improvement, and also do not achieve optimal data compression or secure communication adapted to changing user contexts. Therefore, there exists a need to provide a system that ensures secure and efficient data communication while enabling real-time recognition of user emotions and effective adaptation of services based on emotional state in physical environments.

The specific processing by the specific processing unit 290 of the data processing device 12 in Application Example 2 is realized by the following means.

The present invention provides a server comprising a processor configured to receive user state information from an information acquisition device, analyze the information using a generative model including a machine learning algorithm to recognize the user's emotional state, generate supplementary information representing the recognized emotional state, use this supplementary information to set communication data priority, generate encoding information to improve compression efficiency, provide the encoding information to the information acquisition device for subsequent data transmission, and employ encryption methods for secure data communication. This enables real-time acquisition and recognition of users'emotional states, rapid prioritization and processing of important communication data, effective data compression tailored to context, and robust data security in real-world service environments.

The term “user state information” refers to information relating to the physical, psychological, or emotional status of a user, including but not limited to image data, audio data, or behavioral data acquired in real time from an information acquisition device. The term “information acquisition device” refers to any device or apparatus configured to collect or capture user state information, such as a smart terminal, wearable device, camera, microphone, or sensor-equipped device.

The term “processor” refers to a data processing unit or integrated circuit capable of executing programmed instructions to perform computational, analytical, or controlling functions within a system or server.

The term “generative model” refers to a mathematical or machine learning-based algorithm used for analyzing input data and generating outputs such as analytical results, encoding information, or supplementary information based on learned data patterns.

The term “machine learning algorithm” refers to a computational method that enables a processor or generative model to learn patterns and relationships within data in order to perform analysis, classification, or prediction tasks.

The term “emotional state” refers to the psychological or affective condition of a user, such as happiness, confusion, frustration, or satisfaction, as recognized or inferred from image information or audio information.

The term “supplementary information” refers to metadata or auxiliary data generated by the processor to represent the recognized emotional state of a user, and used to influence or control subsequent processing or communication priority.

The term “communication data priority” refers to a ranking or ordering parameter that determines the precedence or urgency with which communication data is processed, transmitted, or delivered based on contextual conditions or supplementary information.

The term “encoding information” refers to data or parameters generated to improve the efficiency of information compression, such as dictionaries, code tables, or compression schemes used during data transmission between devices.

The term “encryption method” refers to any cryptographic technique or algorithm implemented to ensure the confidentiality, integrity, and security of data communication between the processor and other devices.

In one embodiment, the present invention may be implemented using a server equipped with a processor, a network communication interface, and a memory. The system also includes at least one terminal such as a wearable device, mobile device, or sensor-equipped apparatus capable of acquiring image information and audio information from a user through hardware components such as a camera and microphone.

The terminal is configured to use software, such as a camera application (e.g., Android Camera API or similar interface) and audio capture software (e.g., MediaRecorder), to collect real-time image and audio data corresponding to the user's expressions and voice. The terminal is further configured to process, encrypt, and securely transmit the collected data to the server by leveraging encryption techniques, such as SSL/TLS using OpenSSL libraries.

The server receives the encrypted data, decrypts it using appropriate decryption routines, and stores it in a secure memory area. The server then operates a generative AI model implemented using machine learning frameworks such as TensorFlow or PyTorch. For facial analysis, the server may use image processing libraries such as OpenCV to detect facial regions and extract facial features. For voice analysis, the server may use audio processing tools such as Librosa or TensorFlow Audio to extract and analyze characteristic features from the audio data.

Upon analysis, the server recognizes the user's emotional state by classifying facial and vocal features. The recognition algorithms may detect various emotions such as confusion, satisfaction, or frustration. The server generates supplementary information (emotion metadata) that reflects the user's detected emotional state and determines the priority of subsequent communications based on this information. The server updates its communication management framework (e.g., using middleware or a message broker) to adjust the priority of messages according to the detected emotional urgency.

To further enhance communication efficiency, the server uses its generative AI model to create encoding information such as updated compression dictionaries, referencing patterns in recently received data. The server transmits this encoding information back to the terminal for use in compressing future data, employing efficient data compression schemes such as LZW or Huffman coding implemented in the terminal's communication module.

The terminal receives the latest encoding information and updates its local compression routines accordingly so that subsequent data transmissions are compressed efficiently.

Throughout operation, all communications between the terminal and the server remain encrypted to ensure the security and integrity of user data.

For example, when a user enters a physical retail environment and appears confused, the terminal captures both an image of the user's facial expression and audio of the user's voice as they ask, “Where can I find the discount section?” The terminal encrypts and transmits this data to the server, where the generative AI model recognizes a “confused” emotional state and sets a high priority for this event. The server promptly notifies nearby staff and updates the encoding dictionary based on this event, distributing the new compression information to all terminals. Staff can then respond quickly, improving user satisfaction.

An example of a prompt sentence for the generative AI model may be:

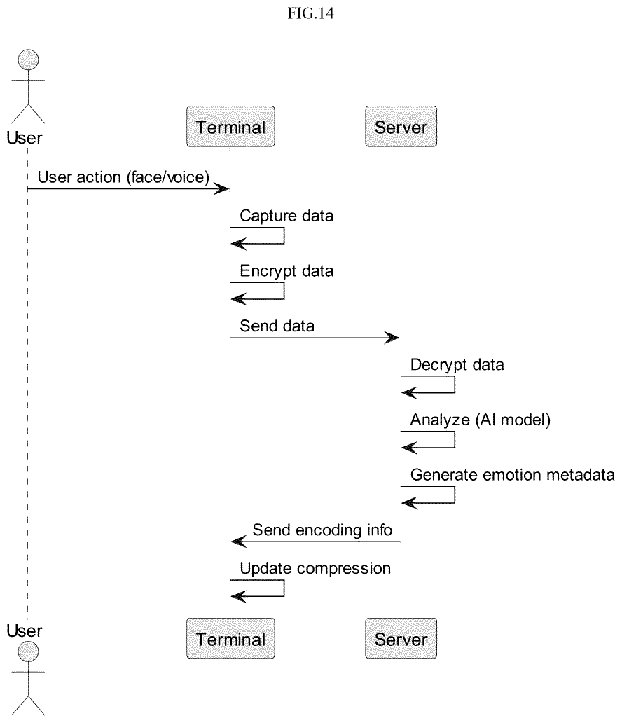

“Write a program that recognizes customer emotions in real time using both facial expression and voice data, and provides immediate feedback to assist in physical retail environments.” The following describes the processing flow using FIG. 14.

### Step 1

The terminal activates its camera and microphone to begin collecting user state information. The terminal uses its camera application and audio recording software to capture real-time image data of the user's face and audio data of the user's voice. The input for this step is the user's physical presence and interaction in the environment, and the output is a set of image files (such as JPEG or PNG) and audio files (such as WAV or MP3) representing the user's facial expressions and voice.

### Step 2

The terminal encrypts the collected image and audio data using encryption libraries that implement protocols such as SSL/TLS. The terminal processes the binary data by applying an encryption algorithm to protect confidentiality during transmission. The input for this step is the raw image and audio files from Step 1, and the output is an encrypted data package ready for secure network transmission.

### Step 3

The terminal establishes a secure wireless communication channel and transmits the encrypted data to the server via Wi-Fi, Bluetooth, or another network interface. The input is the encrypted data package from Step 2, and the output is the transmission of this data from the terminal to the server.

### Step 4

The server receives the encrypted user state information through its communication interface. The server decrypts the data using decryption routines compatible with the encryption scheme of the terminal, and separates the received data into image and audio data files. The input is the encrypted data package transmitted by the terminal, and the output is the decrypted image and audio data files made available for further processing.

### Step 5

The server analyzes the decrypted image and audio data using a generative AI model built on machine learning frameworks such as TensorFlow or PyTorch. The server applies facial analysis algorithms to extract facial features from the image data, and audio analysis algorithms to extract emotional cues from the audio data. The input is the decrypted image and audio data from Step 4, and the output is emotion metadata, such as a JSON object indicating the recognized emotion type (e.g., “confused”) and confidence score.

### Step 6

The server generates supplementary information based on the recognized emotional state and updates the priority of related communication data. The server uses the emotion metadata to determine the urgency and importance of the situation, such as by setting a high priority for events indicating customer confusion. The input is the emotion metadata from Step 5, and the output is an updated message priority setting and the generation of supplementary information reflecting the emotional state.

### Step 7

The server notifies a staff terminal or device by sending a push notification or alert message that includes the detected emotional state and suggested next action. The server prepares and transmits notification data using its communication subsystem. The input is the updated priority and supplementary information from Step 6, and the output is a real-time notification sent to the staff's terminal.

### Step 8

The server processes accumulated user state information and supplementary information to generate new encoding information, such as an adaptive compression dictionary, using the generative AI model. The server analyzes past communication patterns to optimize compression for future data. The input is historical user state information and supplementary information, and the output is a newly generated encoding dictionary or encoding parameters.

### Step 9

The server securely transmits the generated encoding information to the terminal for use in subsequent data transmission. The server uses encryption protocols to ensure the encoding information is sent securely. The input is the newly generated encoding information from Step 8, and the output is the successful delivery of encoding information to the terminal.

### Step 10

The terminal receives the encoding information from the server and updates its compression module accordingly. The terminal verifies and installs the new compression dictionary or parameters, ensuring that future user state information is compressed more efficiently before transmission. The input is the encoding information delivered in Step 9, and the output is an updated terminal compression module ready to process new data transmissions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

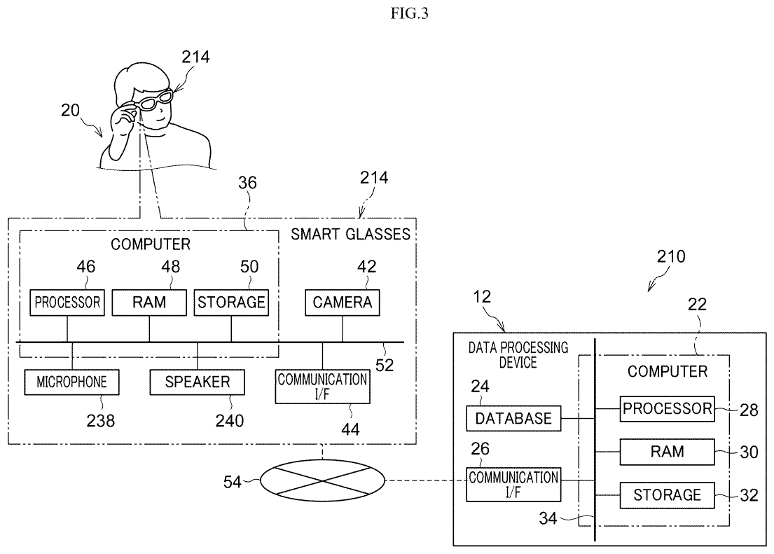

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

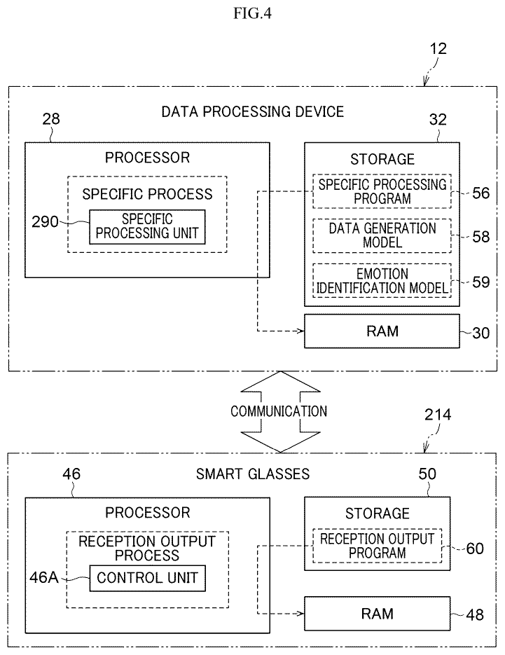

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

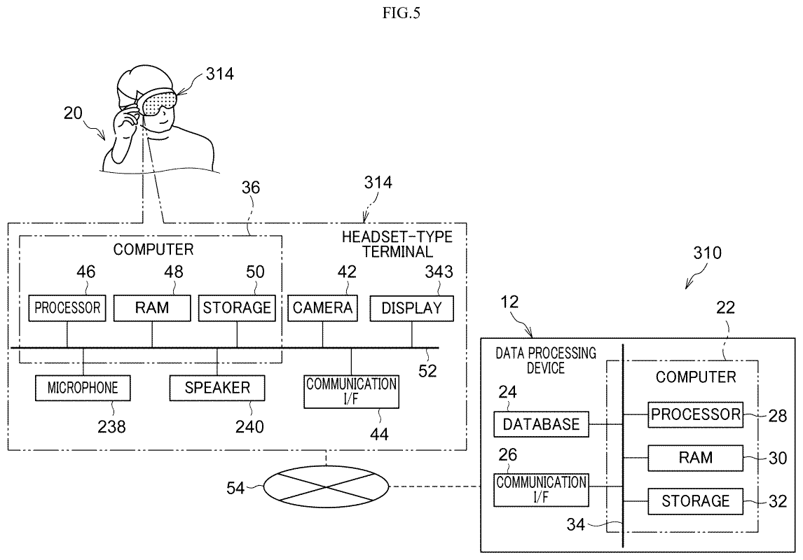

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

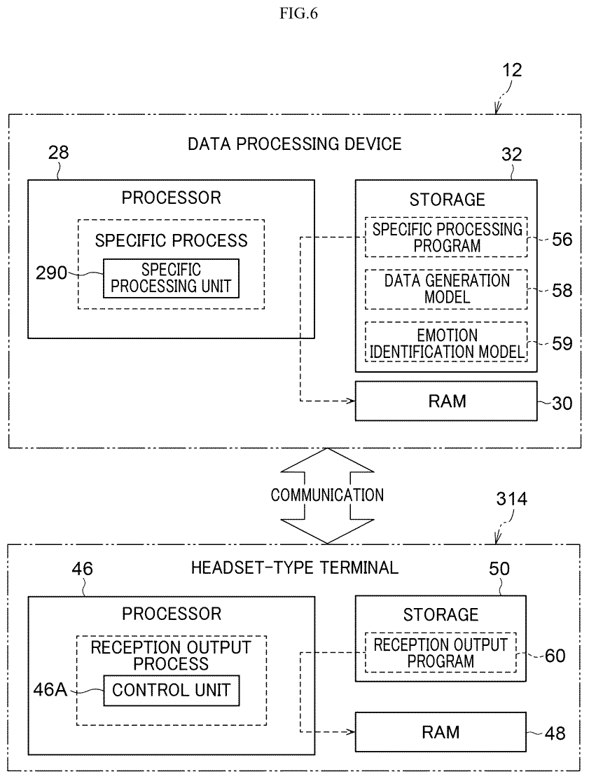

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

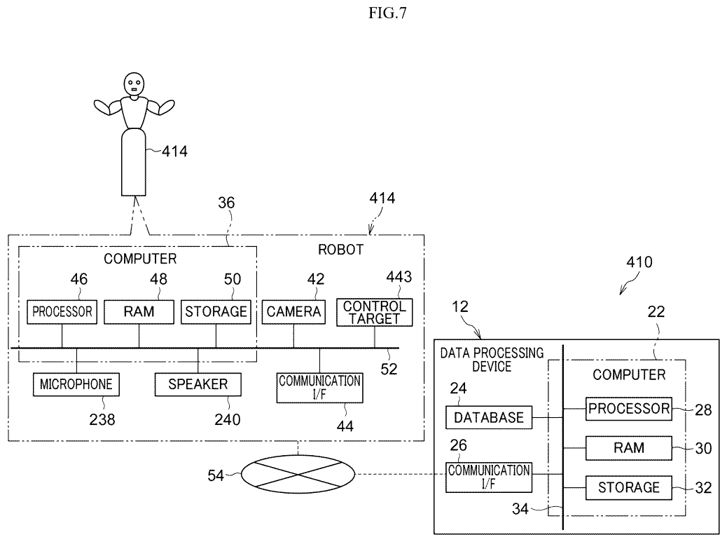

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

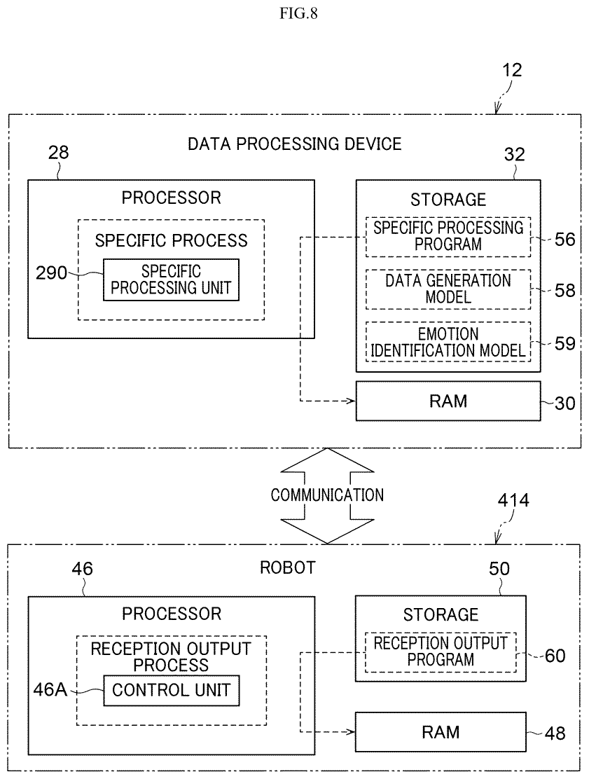

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai. com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

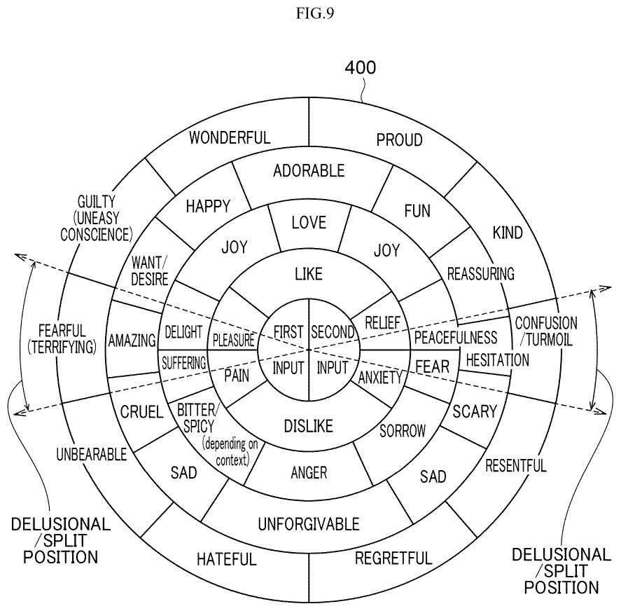

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety.

Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more”and “want to know more”is experienced.

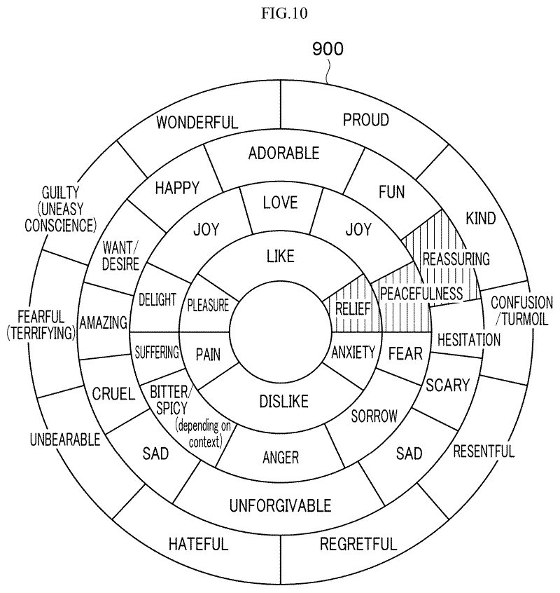

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured”are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure.

This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive information acquired from an input device or a measurement device of an information terminal via a communication network;
analyze the received information using a generative artificial intelligence model and generate encoding information for data compression based on characteristics of the input information, and optimize the encoding information for each information terminal;
distribute the generated encoding information in a structured data format to the information terminal and set the information terminal to utilize the encoding information in subsequent information communication;
apply an encryption method to the information communication between the information terminal and the information processing device to achieve data protection over the communication path;
improve the accuracy or efficiency of the data compression process by using input prompt sentences to the generative artificial intelligence model; and
provide a user with the received information and analysis results from the generative artificial intelligence model by using a visualization technology.

### Supplementary 2

The system according to Supplementary 1, wherein the processor is configured to cause the information terminal to compress newly acquired information, using the distributed encoding information and existing compression software, before transmitting the information.

### Supplementary 3

The system according to Supplementary 1,
wherein the processor is configured to decompress the compressed information based on the encoding information, and analyze or display the decompressed information using the generative artificial intelligence model or visualization technology.

### Application Example 1

### Supplementary 1

A system comprising a processor,
wherein the processor is configured to
receive measurement information acquired from an information collection apparatus, analyze the received measurement information using a generative artificial intelligence model to generate encoding information for compression based on features of the measurement information,
distribute the generated encoding information for compression to the information collection apparatus for use in subsequent transmissions of measurement information, securely transmit and receive measurement information to which the encoding information for compression has been applied by employing an encryption method,
acquire user state data, estimate emotional information by emotion determination technology, and control the communication priority or the encoding information for compression based on the estimated emotional information,
and generate prompt sentences to be input to the generative artificial intelligence model.

### Supplementary 2

The system according to supplementary 1,
wherein the processor is configured to
encode and compress the measurement information in the subsequent transmission from the information collection apparatus by using the generated encoding information for compression.

### Supplementary 3

The system according to supplementary 1,
wherein the processor is configured to decode and restore the compressed measurement information using the generated encoding information for compression and perform processing based on the restored measurement information.

### Example 2

### Supplementary 1

A system comprising a processor,
wherein the processor is configured to
receive data acquired from an observation device,
analyze the received data using a machine learning model to generate reference information for data compression,
distribute the generated reference information to the observation device for use in subsequent data communications,
apply an encryption method to ensure information security in data communications, utilize an emotion analysis apparatus to identify an emotional state of a user from the analyzed data, and
determine a communication priority based on the identified emotional information.

### Supplementary 2

The system according to supplementary 1,
wherein the processor is configured to compress the information for subsequent transmissions using the distributed reference information.

### Supplementary 3

The system according to supplementary 1,
wherein the processor is configured to decompress the compressed information using the distributed reference information for processing.

### Application Example 2

### Supplementary 1

A system comprising a processor,
wherein the processor is configured to
receive user state information acquired from an information acquisition device, analyze image information and audio information included in the received user state information using a generative model including a machine learning algorithm to recognize a user's emotional state,
generate supplementary information representing the recognized emotional state, and set a communication data priority based on the supplementary information,
analyze the received user state information and supplementary information to generate encoding information that improves information compression efficiency,
provide the generated encoding information to the information acquisition device for use in subsequent information transmission,
and employ an encryption method to ensure security of data communication.

### Supplementary 2

The system according to supplementary 1,
wherein the processor is configured to
compress the acquired information using the generated encoding information upon subsequent information transmission from the information acquisition device.

### Supplementary 3

The system according to supplementary 1,
wherein the processor is configured to
decompress information compressed using the generated encoding information and perform processing on the decompressed information.

What is claimed is:

1. A system comprising a processor,
wherein the processor
receives data collected from a terminal,
analyzes the received data using a generative model and generates dictionary data for data compression,
distributes the generated dictionary data to the terminal so that it is used in subsequent data communications,
and ensures communication security by using encryption technology.

2. The system according to claim 1, wherein the processor compresses data by using the generated dictionary data when the terminal transmits data in a subsequent communication.

3. The system according to claim 1, wherein the processor decompresses and processes compressed data using the generated dictionary data.
